(19) United States
(12) Patent Application Publication
(10) Pub. No.: US 2011/0296915 A1
(43) Pub. Date: Dec. 8, 2011

(54) MULTI-AXIS CAPACITIVE ACCELEROMETER

(76) Inventors: Bin YANG, Shenzhen (CN); Yi-Lin Yan, Shenzhen (CN)

(21) Appl. No.: 12/978,590

(22) Filed: Dec. 26, 2010

(30) Foreign Application Priority Data
Jun. 7, 2010 (CN) 201010193781.2

(51) Int. Cl. G01P 15/125

(52) U.S. Cl. 73/514.32

(57) ABSTRACT

A accelerometer includes a base, a pair of fixed sensing blocks anchored to the base, a plurality of elastic linkages connected to the base, and a movable sensing block sandwiched between the pair of fixed sensing blocks and suspended in the base by the elastic linkages for moving either along a first or a second axes or shifting along a third axes. Each fixed sensing block defines four fixed sensing sections and each fixed sensing section sets in space with respect to the other fixed sensing sections. A projection of each fixed sensing section along a third axes exceeds the movable sensing block in a direction of the first and second axis, respectively.

### FIELD OF THE INVENTION

The disclosure relates to an accelerometer which is manufactured by Micro Electro Mechanical System (MEMS) technology and has the capability of sensing three axes acceleration.

### RELATED ART OF THE INVENTION

MEMS accelerometers are known for more than 30 years and they are widely used in different areas. Automotive air-bag applications currently represent the biggest MEMS accelerometer market.

There are only few known MEMS three-axis (or 3D) accelerometers that can measure all three components of an acceleration vector.

The market for 3D accelerometers includes hand-held devices (cell phones, PDAs, hand-held computers, gaming devices, remote controls, etc.); health and sport products (ergometers, smart shoes, patient posture indicators, pacemakers, biometric devices and systems, etc.); monitoring systems for civil objects (bridges, buildings, etc.); smart toys; virtual reality devices, and more. However, available 3D accelerometers impede market growth because of their high cost. Most of the above markets require low-cost, stable and reliable 3D accelerometers. Therefore, there is a need for a low-cost single die 3D accelerometer that possesses all the above-mentioned features.

U.S. Pat. No. 5,485,749 discloses a structure of a three-axis accelerometer. Fabrication of this 3D accelerometer requires special silicon-on-insulator (SOI) material. SOI silicon wafers are standard initial material for many semiconductor devices. SOI wafers are fabricated using fusion bonding of two silicon wafers. At least one silicon wafer contains an insulator layer at the bonding interface. Therefore, two layers of silicon are electrically insulated after bonding. Thermally grown silicon dioxide is usually used as a dielectric layer at the interface of the bonded silicon wafers. After bonding, one wafer is usually thinned down to a predetermined thickness that is typically much smaller than the initial thickness of the wafer. This thin layer is used for fabrication of functional components of semiconductor devices and is called a device layer. The other wafer is typically not thinned and is called a handle wafer or handle layer.

Either one or both wafers used for SOI wafer fabrication can be micromachined before bonding. A profile is formed at the sides of the wafers that are facing each other during the bonding process. This allows making SOI wafers with buried cavities. In U.S. Pat. No. 5,485,749, the thickness of the device layer is much smaller than the thickness of the handle layer. The buried cavities are located at the interface between the device and the handle layers.

The structure of the 3D accelerometer contains a frame, a proof mass and an elastic element (suspension beams) that connects the frame and the proof mass. When acceleration is applied to the proof mass, it tends to move with respect to the frame causing mechanical stress in the suspension beams. Piezoresistors located on the suspension beams are used to generate electrical signals in response to the mechanical stress. All three components of acceleration vector can be determined by processing the signals from the piezoresistors.

The proof mass is formed by double-side etching. In the structure shown in U.S. Pat. No. 5,485,749, deep backside wet etching is used to etch through the handle layer. The device layer is micromachined by etching slots from the front side of the SOI wafer. These slots are connected with the cavities etched from the backside of the wafer and separate the proof mass and the frame.

The suspension beams are formed by etching slots through the device layer from the front side of the SOI wafer. The 3D accelerometer structure described above has several disadvantages.

The state-of-the-art multi-axis accelerometers integrate both sensor elements and IC circuits for analog and digital signal conditioning and processing on the same chip. Therefore, it is desirable to minimize the area occupied by the proof mass and the suspension on the front side of the chip where the IC circuits are located.

U.S. Pat. No. 5,485,749 discloses an accelerometer which can sense acceleration on multi direction. However, the accelerometer has complicate structures and is difficult to be manufactured with low cost.

### BRIEF DESCRIPTION OF THE DRAWINGS

FIG. 1 is an illustrative assembled view of a multi-axis capacitive accelerometer in accordance with an exemplary embodiment of the present invention;

FIG. 2 is an exploded view of the multi-axis capacitive accelerometer;

FIG. 3 is an isometric view of the multi-axis capacitive accelerometer of the exemplary embodiment, a part thereof being cut away;

FIG. 4 is similar to FIG. 3, but from another aspect;

FIG. 5 is an illustrative top view of the multi-axis capacitive accelerometer of the embodiment;

FIG. 6 is an enlarged view of Part C in FIG. 5;

FIG. 7 is an illustrative top view of an upper fixed sensing block of the multi-axis capacitive accelerometer of the exemplary embodiment;

FIG. 8 is an illustrative top view of a lower fixed sensing block of the multi-axis capacitive accelerometer of the exemplary embodiment.

### DETAILED DESCRIPTION OF THE EXEMPLARY EMBODIMENT

Reference will now be made to describe the exemplary embodiment of the present invention in detail.

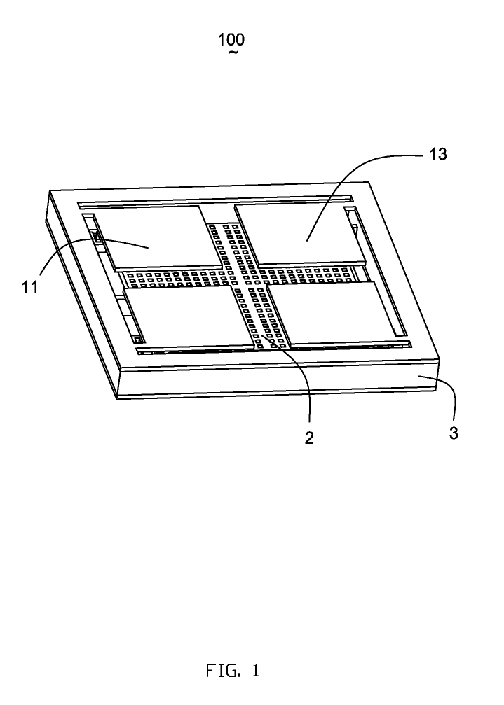

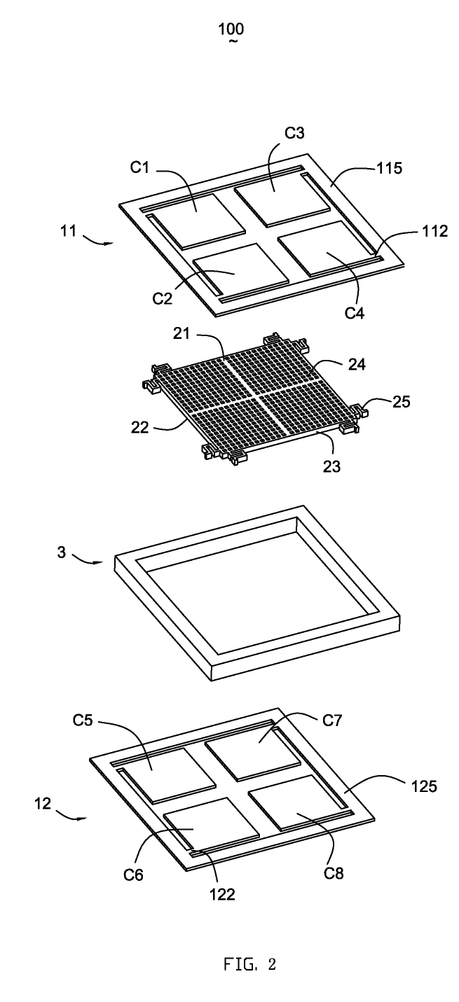

Referring to FIGS. 1 and 2, a multi-axis capacitive accelerometer 100 in accordance with an exemplary embodiment of the present invention for measuring acceleration in three mutually orthogonal axis, a first axes X, a second axes Y and a third axes Z, comprises a base 3, a plurality of elastic linkages 25 connected to the base 3, a pair of fixed sensing blocks mounted on the base 3, a movable sensing block 2 sandwiched between the pair of fixed sensing blocks and suspended in the base 3 by the elastic linkages 25. Each fixed sensing block defines an upper surface 13 and a lower surface (no labeled) opposite to the upper surface. The elastic linkages 25 drive the movable sensing block 2 to move either along the first axes X parallel to the upper surface 13 of each fixed sensing block or a second axes Y perpendicular to the first axes Y and parallel to the upper surface 13 of each fixed sensing block or shift along a third axes Z perpendicular to the first and second axis X and Y, respectively.

Referring to FIG. 2, the pair of fixed sensing blocks defines an upper fixed sensing block 11 and a lower fixed sensing block 12 having the same structure as the upper fixed sensing block 11. Each fixed sensing block defining a plurality of fixed sensing sections. Each fixed sensing section is located adjacent a corner of the base and is isolative to each other;

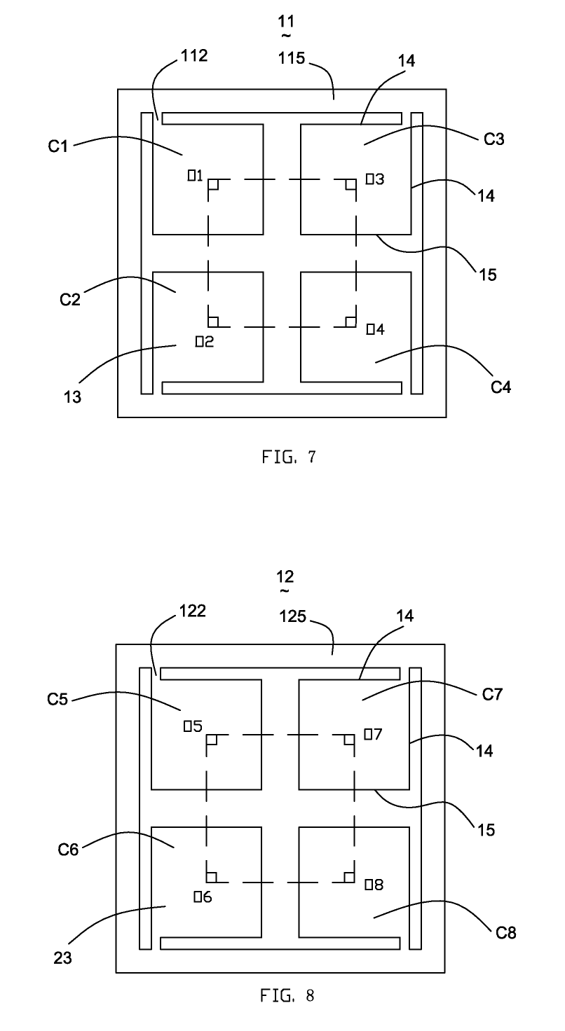

Referring to FIGS. 2 and 7, the upper fixed sensing block 11 defines an upper fixed frame 115 anchored to the base 3 and four upper fixed sensing sections received into the upper fixed frame 115, named as a first upper fixed sensing section C1, a second upper fixed sensing section C2, a third upper fixed sensing section C3, and a fourth upper fixed sensing section C4. The first, second, third and fourth upper fixed sensing sections C1, C2, C3 and C4 have the same structure to each other. Each of the upper fixed sensing sections is located adjacent a corner of the frame 115 respectively with an upper connecting portion 112 connecting to the frame 115. Each of the upper fixed sensing section does no directly connect to each other. Each upper fixed sensing sections C1, C2, C3 and C4 defines an inner upper sidewall 15 far from the base 3, an outer upper sidewall 14 near the base 3, and a upper connecting portion 112 connecting the inner and outer upper sidewalls 15 and the upper fixed frame 115, respectively. The first upper fixed sensing section C1 defines a first upper center point O1. In the same manner, there are a second upper center point O2, a third upper center point O3 and a fourth upper center point O4. The first upper center point O1 together with two adjacent center points O2 and O3 forms a first upper angle. In the same manner, there is a second upper angle (no labeled), a third upper angle and fourth upper angle. The first, second, third, fourth upper angles are configured to be a right angle.

Referring to FIGS. 2 and 8, the lower fixed sensing block 12 defines an lower fixed frame 125 anchored to the base 3 and four lower fixed sensing sections received into the lower fixed frame 125, named as a first lower fixed sensing section C5, a second lower fixed sensing section C6, a third lower fixed sensing section C7, and a fourth lower fixed sensing section C8. The first, second, third and fourth lower fixed sensing sections C5, C6, C7 and C8 have the same structure to each other. Each of the lower fixed sensing sections is located adjacent a corner of the frame 125 respectively with a lower connecting portion 122 connecting to the frame 125. Each of the upper fixed sensing section does no directly connect to each other. Each lower fixed sensing sections C5, C6, C7 and C8 defines an inner lower sidewall 25 far from the base 3, an outer lower sidewall 24 near the base 3, and a lower connecting portion 122 connecting the outer lower sidewall 25 and the lower fixed frame 125. The first lower fixed sensing section C5 defines a first lower center point O5. In the same manner, there is a second lower center point O6, a third lower center point O7 and a fourth lower center point O8. The first lower center point O5 together with two adjacent center points O6 and O7 forms a first lower angle. In the same manner, there are a second lower angle (no labeled), a third lower angle and fourth lower angle. The first, second, third, fourth lower angles are configured to be a right angle.

Referring to FIG. 2, the movable sensing block 2 defines a first surface 21, a second surface 22 opposite to the first surface 21, a plurality of micro-holes 24 drilled from the upper surface 21 completely through the lower surface 22 for reducing damping effect, and a plurality of laterals 23 connecting with the first second surfaces 21 and 22.

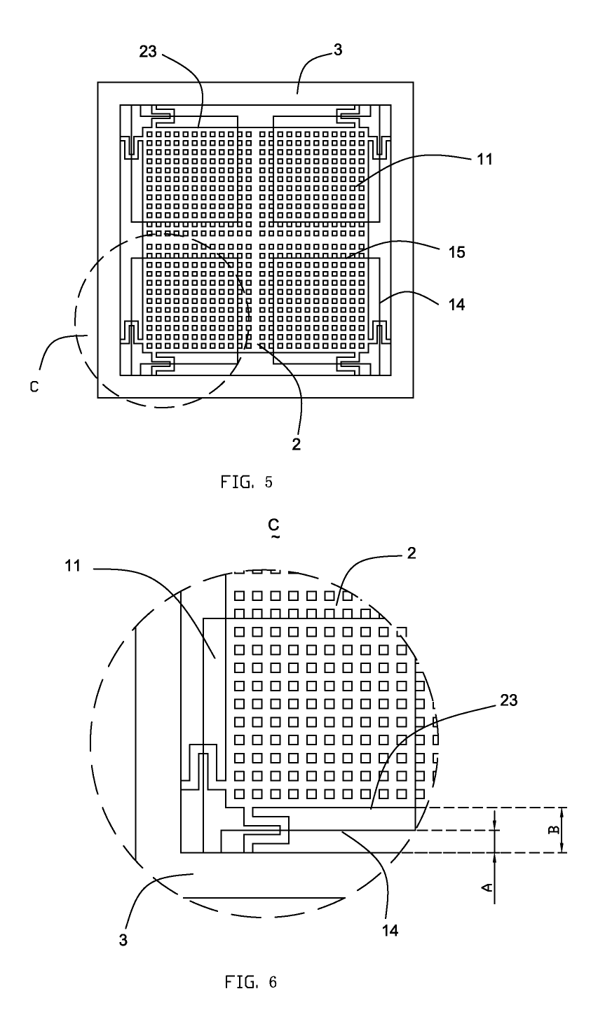

Referring to FIGS. 2, 5 and 6, it is optional that an outline of each fixed sensing section is configured to be a cube. A projection of each fixed sensing section along a third axes exceeds the movable sensing block in a direction along the first and second axis, respectively

Referring to FIGS. 2, 5 and 6, each outer sidewall 14 or 24 of each fixed sensing section forms a first shortest distance B together with the inner side of the base 3. The laterals 23 of the movable sensing block 2 form a second shortest distance A together with the inner side of the base 3. The outer sidewall 14, 24 of the fixed sensing block is closer to the inner side of the base 3 than the laterals 23 of the movable sensing block 2. In other words, the second shortest distance B is smaller than the first shortest distance A.

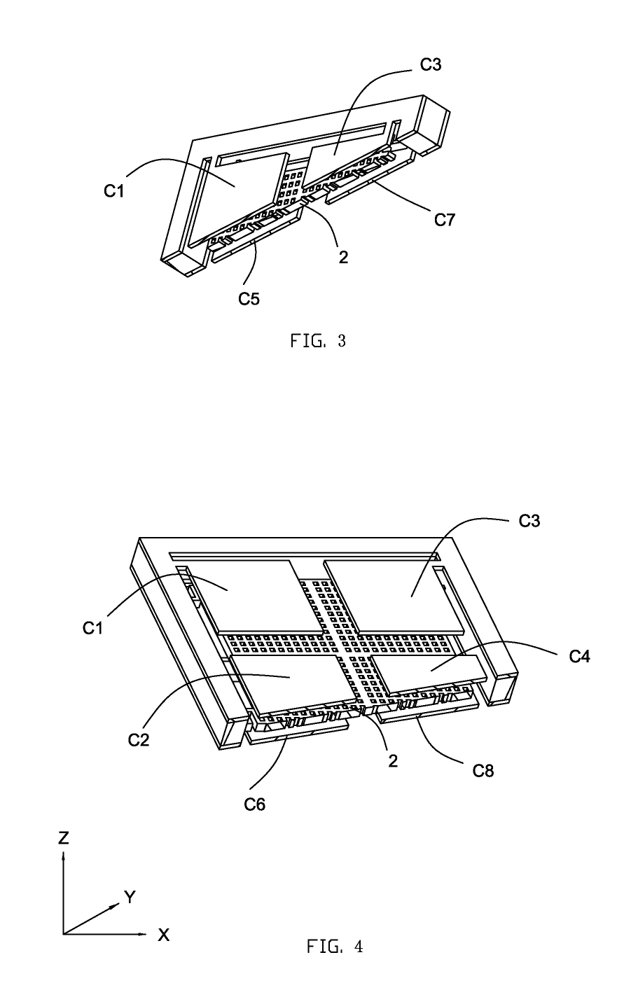

Referring to FIGS. 2 to 4, when the movable sensing block 2 is driven by an acceleration and moves along the first X or the second axis Y, the overlapping area of the movable sensing block 2 and each corresponding fixed sensing block 11, 12 is changed, and the multi-axis capacitive accelerometer 100 of the present invention can sense and orient a motion along the first X and/or the second axis Y according to the variances of the capacitance value between each fixed sensing block 11, 12 and the movable sensing block 2. When the movable sensing block 2 is driven by an acceleration and moves along the third axes Z, a distance between the movable sensing block 2 and each fixed sensing block 11, 12 is also changed, and the multi-axis capacitive accelerometer 100 of the present invention can sense and orient a motion along the third axes Z according to the variances of the capacitance value between each fixed sensing block 11, 12 and the movable sensing block 2.

According to the multi-axis capacitive accelerometer, the structure is simple, and simultaneously, the sensitivity of the accelerometer is effectively enhanced.

While the present invention has been described with reference to a specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A multi-axis capacitive accelerometer comprising:
a base;
a pair of fixed sensing blocks anchored to the base, each fixed sensing block defining a plurality of fixed sensing sections and an upper surface;
a plurality of elastic linkages connected to the base;
a movable sensing block sandwiched between the pair of fixed sensing blocks for forming a plurality of capacitive structures together with each corresponding fixed sensing section and suspended in the base by the elastic linkages for being capable of moving either along a first axes parallel to the upper surface of each fixed sensing block or a second axes perpendicular to the first axes and parallel to the upper surface of each fixed sensing block or shifting along a third axes perpendicular to the first and second axis, respectively;
wherein, each fixed sensing section is located adjacent a corner of the base and is isolative to each other;
a projection of each fixed sensing section along a third axes exceeds the movable sensing block in a direction along the first and second axis, respectively.

2. The multi-axis capacitive accelerometer as described in claim 1, wherein each fixed sensing section has the same structure to each other.

3. The multi-axis capacitive accelerometer as described in claim 2, wherein each fixed sensing section defines a center point and each center point together with two adjacent centers point forms a right angle.

4. The multi-axis capacitive accelerometer as described in claim 3, wherein the movable sensing block further defines a plurality of perforations therethrough for reducing damping effect.

5. The multi-axis capacitive accelerometer as described in claim 4, wherein an outline of each fixed sensing section is configured to be a cube.

6. A multi-axis capacitive accelerometer, comprising:
a frame;
an upper fixed sensing block connected to the frame;
a lower fixed sensing block connected to the frame and parallel to the upper fixed sensing block;
a movable sensing block located between and parallel to the upper fixed sensing block and the lower fixed sensing block, the movable sensing block being connected to the frame by a plurality of elastic linkages;
each of the upper and lower fixed sensing blocks defining a plurality of fixed sensing sections arranged in rows and columns;
wherein, a overlapping area between the fixed sensing sections in one row and the movable sensing block is increased and a overlapping area between the fixed sensing blocks in another row and the movable sensing block is reduced when the movable sensing block moves along a direction perpendicular to the row; and
wherein a overlapping area between the fixed sensing sections in one column and the movable sensing block is increased and a overlapping area between the fixed sensing blocks in another column and the movable sensing block is reduced when the movable sensing block moves along a direction parallel to the row; and
wherein a distance between the movable sensing block and one of the upper fixed sensing block and the lower fixed sensing block is increased and a distance between the movable sensing block and the other of the upper fixed sensing block and the lower fixed sensing block is reduced when the movable moves along a direction perpendicular to both of the row and the column.

7. The multi-axis capacitive accelerometer as described in claim 6, wherein each of the upper and lower fixed sensing blocks defines two fixed sensing sections arranged in row, respectively.

8. The multi-axis capacitive accelerometer as described in claim 6, wherein each of the upper and lower fixed sensing blocks defines two fixed sensing sections arranged in column, respectively

9. The multi-axis capacitive accelerometer as described in claim 8, wherein each fixed sensing section has the same structure to each other.

10. The multi-axis capacitive accelerometer as described in claim 9, wherein each fixed sensing section defines a center point and each center point together with two adjacent centers point forms a right angle.
